(19) United States
(12) Patent Application Publication
(10) Pub. No.: US 2010/0097649 A1
(43) Pub. Date: Apr. 22, 2010

(54) Printer controller, printing server, and print system

(75) Inventor: Toshio Akiyama, Ibaraki-ken (JP)

Correspondence Address: THE NATH LAW GROUP, 112 South West Street, Alexandria, VA, 22314, US

(73) Assignee: RISO KAGAKU CORPORATION, Tokyo (JP)

(21) Appl. No.: 12/588,574

(22) Filed: Oct. 20, 2009

(30) Foreign Application Priority Data
Oct. 21, 2008 (JP) P2008-271158

(51) Int. Cl. G06F 3/12

(52) U.S. Cl. 358/1.15

(57) ABSTRACT

A printer controller is operable to make an information processor execute a process of outputting a print data to a printing machine provided with a plurality of sheet feeders and adapted to set up feeder information, and have the information processor work as a feeder information acquirer, a printing condition setup acceptor, a print data generator, and a feeder setter, the feeder setter serving to set up a sheet feeder in which placed print sheets have an identical size to a sheet size set up as a printing condition, as a sheet feeder for print, the print data generator serving to generate the print data to have an image frame formed by the print data oriented in accordance with an orientation of print sheets placed in the sheet feeder as set up, while forming the image frame in accordance with a type of print sheets placed in the sheet feeder as set up.

### BACKGROUND OF THE INVENTION

1. Field of the Invention

The present invention relates to a printer controller, a printing server, and a print system configured for acquisition of information on print sheets placed in a system of sheet feeders of a printing machine, to select a sheet feeder to set for application to a printing job, generating a print data in accordance with a sheet in the selected sheet feeder.

2. Description of Related Arts

Given a frame of image, the printing needs the print size and the orientation to be set in accord with a size and an orientation of a print sheet in use, to avoid, among others, printing an image frame extending out of an edge of the print sheet, or leaving undue margins. Therefore, against disaccord between combination of size and orientation of given image frame and combination of size and orientation of print sheet in use, there has been an indication of sheet mismatch to promote an exchange of sheet feeder, resetting of printing conditions, etc.

Japanese Patent Application Laid-Open Publication No. 2004-177741 has disclosed a printing machine adapted to control orientation of image frames to be printed in accordance with information on orientation of print sheets set up in a feed system, in the interest of saving time for a match to be established between orientation of given image frame and orientation of print sheet in use. Further, the above-noted patent document has disclosed processing a given frame of image data to provide a longitudinal sense in accordance with a type of sheet set up in the feed system. In other words, for use of a type of sheet to be set in consideration of a longitudinal sense, such as that of a letter head, the image frame to be printed is oriented in accordance with the sense of sheet.

### SUMMARY OF THE INVENTION

However, some types of sheet may be different in color shade of background, or may exhibit different tendencies such as in deposition of an image forming medium, e.g. of an ink, so it is desirable to control not simply the longitudinal sense of image frame, but also the very image frame to be formed on a print sheet in use in accordance with properties of the sheet. In this respect, under a condition given a user's designation of a specific sheet feeder, it is not so difficult to generate a print data in accordance with a type of print sheet placed in the designated sheet feeder. Instead, absent user's designation of any specific sheet feeder, it is not easy to generate a print data in accordance with an available type of print sheet.

Accordingly, it is an object of the present invention to provide a printer controller, a printing server, and a print system adapted to generate a print data in accordance with the type of print sheet, even under a condition absent user's designation of specific sheet feeder.

To achieve the object described, according to a first aspect of the present invention, a computer program product providing a printer controller configured for an information processor to execute a process of outputting a print data to a printing machine provided with a plurality of sheet feeders and adapted to set up feeder information including information on a size, an orientation, and a type of print sheets placed in a respective sheet feeder, the computer program product comprises a feeder information acquirer configured to acquire the feeder information from the printing machine, a printing condition acceptor configured to accept a set of printing conditions including a sheet size and a sheet type set up as printing conditions; and a print data generator configured to generate the print data to have the printing machine form a frame of images, the printer controller being configured to have the information processor work as a feeder setter to set up a sheet feeder for print, the feeder setter being adapted, to set up a sheet feeder in which placed print sheets have an identical size to a sheet size set up as a printing condition, as the sheet feeder for print, in accordance with the feeder information as acquired, the print data generator being adapted to generate the print data to have an image frame formed by the print data oriented in accordance with an orientation of print sheets placed in the sheet feeder set up as the sheet feeder for print, and form the image frame in accordance with a type of print sheets placed in the sheet feeder as set up.

To achieve the object described, according to a second aspect of the present invention, a printing server is configured to output a print data to a printing machine provided with a plurality of sheet feeders and adapted to set up feeder information including information on a size, an orientation, and a type of print sheets placed in a respective sheet feeder, the printing server comprising a feeder information acquirer configured to acquire the feeder information from the printing machine, a printing condition acceptor configured to accept a set of printing conditions including a sheet size and a sheet type set up as printing conditions, a print data generator configured to generate the print data to have the printing machine form a frame of images, and a feeder setter to set up a sheet feeder for print, the feeder setter being adapted, to set up a sheet feeder in which placed print sheets have an identical size to a sheet size set up as a printing condition, as the sheet feeder for print, in accordance with the feeder information as acquired, the print data generator being adapted to generate the print data to have an image frame formed by the print data oriented in accordance with an orientation of print sheets placed in the sheet feeder set up as the sheet feeder for print, and form the image frame in accordance with a type of print sheets placed in the sheet feeder as set up.

To achieve the object described, according to a third aspect of the present invention, a print system including a printing machine provided with a plurality of sheet feeders and adapted to set up feeder information including information on a size, an orientation, and a type of print sheets placed in a respective sheet feeder, and a printing server configured to output a print data to the printing machine, the printing server comprising a feeder information acquirer configured to acquire the feeder information from the printing machine, a printing condition acceptor configured to accept a set of printing conditions including a sheet size and a sheet type set up as printing conditions, a print data generator configured to generate the print data to have the printing machine form a frame of images, and a feeder setter to set up a sheet feeder for print, the feeder setter being adapted, to set up a sheet feeder in which placed print sheets have an identical size to a sheet size set up as a printing condition, as the sheet feeder for print, in accordance with the feeder information as acquired, the print data generator being adapted to generate the print data to have an image frame formed by the print data oriented in accordance with an orientation of print sheets placed in the sheet feeder set up as the sheet feeder for print, and form the image frame in accordance with a type of print sheets placed in the sheet feeder as setup.

### BRIEF DESCRIPTION OF DRAWINGS

FIG. 1 is a block diagram of a print system according to an embodiment of the present invention.

FIG. 2 is a schematic longitudinal sectional view of a printing machine in the print system of FIG. 1, including a system of sheet feeders, a sheet transfer route, and a sheet stacking discharge system.

FIG. 3 is a functional block diagram of the printing machine of FIG. 2.

FIG. 4 is an illustration of a menu frame for sheet size registration of a PC (personal computer) in the print system of FIG. 1.

FIG. 5 is a flowchart of control actions for a user defined sheet size acquisition process of a printer controller of the PC in the print system of FIG. 1.

FIG. 6 is an illustration of a printing machine property frame for accepting printing conditions to be set in the print system of FIG. 1.

FIGS. 7A and 7B are illustrations of pull-down menus at fields of original sheet size and output sheet size, respectively, in the property frame of FIG. 6.

FIG. 8 is a flowchart of control actions for a feed system setup process and a print data generation process of the printer controller in the print system of FIG. 1.

FIGS. 9A and 9B are illustrations of pull-down menus at fields of feeder selection and sheet type, respectively, in the property frame of FIG. 6, and FIG. 9C, an illustration of a menu for selection of frame rotation.

FIG. 10 is a diagram of a list of ranks of priority associated with the feed system of the printing machine of FIG. 2.

### DETAILED DESCRIPTION OF EMBODIMENT

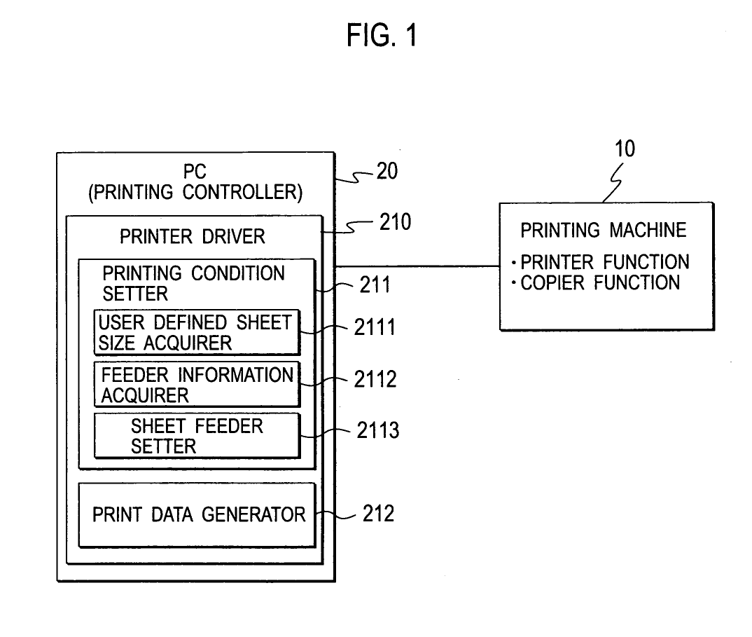

There will be described an embodiment of the present invention, with reference to the drawings. FIG. 1 shows, in block diagram, a print system according to the embodiment. As illustrated in the figure, the print system includes a printing machine 10, and a PC (personal computer) 20 adapted to function as a printing server. This print system is made up as a LAN (local area network) in which the printing machine 10 is shared by a plurality of personal computers including the PC 20. The printing machine 10 may provide a dedicated service for the PC 20, using a private one-to-one connection.

The printing machine 10 has an incorporated color printer mechanism of a forced inkjet system with a set of print heads for propelling arrays of ink droplets to make a print, and is adapted to function as a printer for printing a frame of images according to a print data sent from the PC 20, and as a copier for scanning an original sheet on a platen to make a duplicate printing.

The printing machine 10 includes a system of sheet feeders, and is adapted to accept from user a size, an orientation, and a type of print sheets placed in a respective sheet feeder. The sheet type may be, for instance, a plain sheet, an IJ matte sheet, a high-quality sheet, etc. The printing machine 10 has a variety of regular sheet sizes, such as an A4, an A3, and a B5, registered in advance. It is adapted to accept registration of any user defined sheet size that user can designate besides the regular sheet sizes.

The PC 20 has a set of program files installed therein as a set of printer driving elements compatible with the printing machine 10, and configured to be executed by a CPU (central processing unit) in the PC 20, to operate as a printer controller 210 for the printing machine 10. By operation of the printer controller 210, the PC 20 is adapted to work as a printing server. The set of program files in the PC 20 can be transported through a communication line, or by use of recording medium or the like, for execution at another information processor to provide a printer controller.

The printer controller 210 is adapted to follow an instruction from user to generate a print data, such as that of a document to be printed, to output to the printing machine 10. For this process, the printer controller 210 is provided with a printing condition setter 211 and a print data generator 212. The printing condition setter 211 is configured to accept from user a set of printing conditions set up at the PC 20 end, as necessary, including an acceptance of defaults or designations, if any, of print quality, copy set number, sheet size, sheet orientation, sheet type, sheet stacker, sheet feeder, etc. The print data generator 212 is configured to generate a print data as a sequence of data according to: a document designated as an object to be printed, containing pixel data, editorial data, and the like; and a set of setup printing conditions accepted by the printing condition setter 211. The generated print data is to be output to the printing machine 10.

The printing condition setter 211 includes a user defined sheet size acquirer 2111, a feeder information acquirer 2112, and a sheet feeder setter 2113.

The user defined sheet size acquirer 2111 is configured to acquire from the printing machine 10, a set of pieces of information on size of a user defined sheet registered at the printing machine 10 end. The feeder information acquirer 2112 is configured to acquire from the printing machine 10, a set of pieces of feeder information including sizes, orientations, and types of print sheets placed in sheet feeders set up at the printing machine 10 end.

The sheet feeder setter 2113 is configured to determine a sheet feeder, to set up for print, in accordance with a set of printing conditions accepted from user by the printing condition setter 211, and a set of pieces of feeder information acquired from the printing machine 10 by the feeder information acquirer 2112. Absent designation of specific feeder by user, the sheet feeder setter 2113 is adapted to select a sheet feeder to set up for print, as the sheet feeder has placed therein print sheets of a size corresponding to a default size that has been set up as a printing condition.

The print data generator 212 is adapted as necessary to generate such a print data that represents a frame of images rotated to print in accord with an orientation of print sheets placed in a sheet feeder used for the printing. Further, it is adapted to generate such a print data as processed to form a frame of images consistent with a type of print sheets placed in a sheet feeder used for the printing. More specifically, it is adapted as necessary to generate a print data processed for a color matching to be consistent with a type of print sheets placed in a sheet feeder used to print that, and generate a print data controlled to have propelling conditions, such as a maximal ink-droplet propelling rate per pixel, met in a manner consistent with a type of print sheets placed in a sheet feeder used to print this.

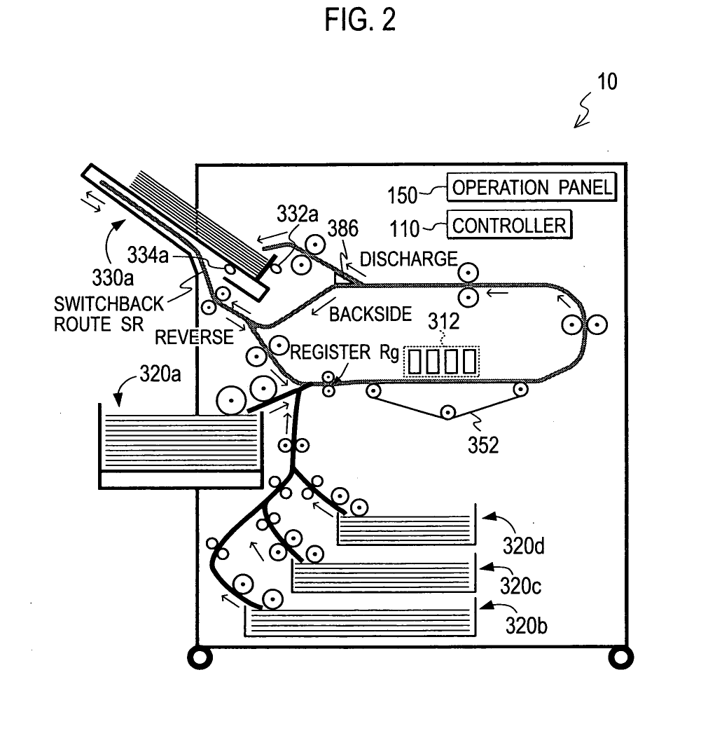

FIG. 2 is a schematic longitudinal sectional view of the printing machine 10 including a sheet feed system, a sheet transfer mute, and a sheet stacking discharge system according to the present embodiment. As illustrated in the figure, in the printing machine 10, the feed system has a first feed tray 320b, a second feed tray 320c, a third feed tray 320d, and a feed rack 320a, and the discharge system has a face-down discharge tray 330a. The discharge system may have two or more discharge trays, including a face-up discharge tray, and a post-handling facility such as for a punching and stapling.

The printing machine 10 is controllable to have a print sheet fed from any sheet feeder, printed by a prescribed number of print heads 312, and discharged to stack on the discharge tray 330a. This tray 330a is arranged on a top of the printing machine 10, where each printed sheet is discharged with a printed face down.

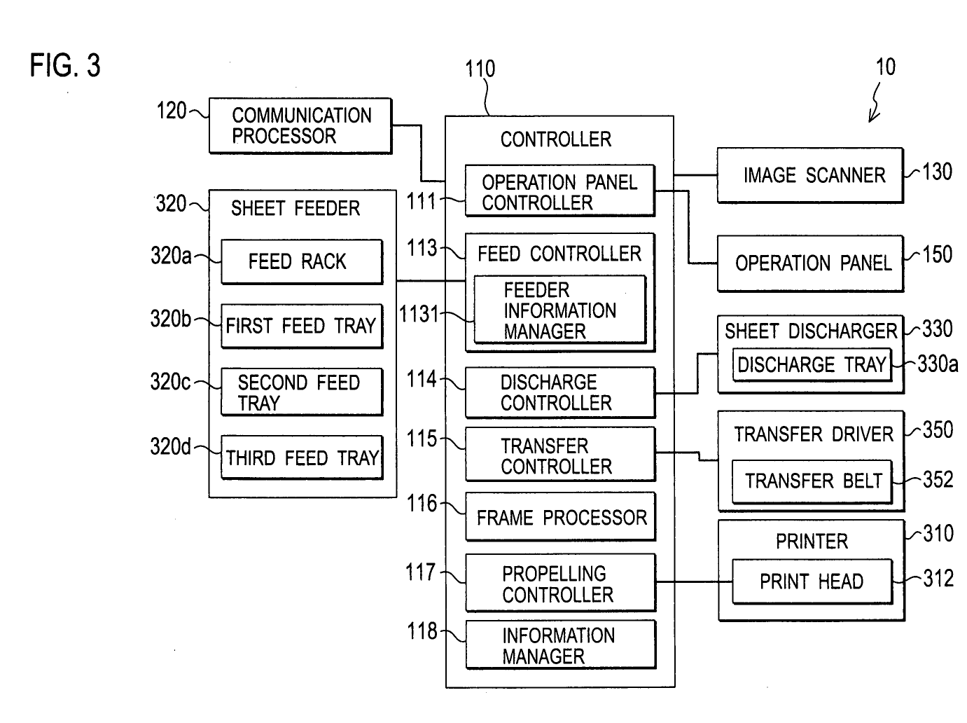

The printing machine 10 is configured as a printer with a printing mechanism including four print heads 312 that have arrays of ink-droplet propelling nozzles extending in a direction perpendicular to a sheet transfer direction. The print heads 312 are individually operable every ink color, i.e., they are each operable to propel an array of droplets of ink of a corresponding one of four colors being pure black and three primary colors, to make a color print by lines. The printing machine 10 includes: an internal controller 110 configured with computer elements, such as a CPU and memories, arranged on a controller substrate; an operation panel 150 configured to accept touch-panel operations; and other functional components (not shown). The printing machine 10 has an internal or external image scanner 130 (refer to FIG. 3).

There is a series of print sheets fed one by one from any sheet feeder, and transferred along a corresponding one of feed paths (represented by bold solid lines in FIG. 2) in a machine housing by associated drives such as rollers constituting a transfer driver 350 (refer to FIG. 3), to lead to a register Rg. The register Rg is configured with paired registration rollers, to set a leading edge of sheet in position, establishing an alignment of sheet free of angular deviations. Each fed sheet is temporarily stopped at the register Rg, to correct oblique attitude if any. For provision of an allowance for attitude correction, feed rollers of the sheet feeder are controlled to force each sheet fed into a slacken state to stop, before a re-feed into the printing mechanism at a prescribed timing.

The re-fed sheet is bound to a looped transfer belt 352 facing the print heads 312, to thereby convey at a speed preset as a printing condition, while propelling ink droplets from the print heads 312 to an upside of the sheet, forming images thereon by lines.

The print sheet as printed on the upside is unbound from the transfer belt 352 to further transfer in the machine casing by drives such as rollers. On the way, it is directed by a route selector 386 toward the discharge tray 330a, to discharge, stacking on the discharge tray 330a with the printed side down.

The discharge tray 330a is set in position protruding from the machine housing, and has a thickness. The discharge tray 330a is inclined, and formed with a stop wall at the lower end of inclination, so each discharged sheet is caused to slip downward along the inclination, and naturally trimmed on the way by the wall, to be piled.

The discharge tray 330a is permitted to have print sheets stacked thereon up to a permissible sheet number predetermined in terms of a distance from the tray 330a, and provided with a sheet-full sensor 332a as an excessive stack detector for detecting a stack amount of print sheets, i.e., a stack height exceeding a preset threshold. Further, the discharge tray 330a is provided with a tray-empty sensor 334a for detecting an empty state of the tray 330a.

The printing machine 10 is controllable for a duplex printing to make a print on a front side of a sheet, and after a lapse of time, make another print on a backside of the sheet. As used herein, for the duplex printing, the term “front side” means one side of a sheet used or to be used for an anterior print, and the term “backside”, the other side of the sheet for a posterior print. In duplex printing, after a print made on the front side of a sheet, this sheet is transferred along a right section of the transfer route, whereby it is reversed to render the front side down at a top section of the transfer route. In time, the route selector 386 is operated, not to lead the sheet to the discharge tray 330a, but to transfer still inside the machine housing. Then, the sheet is pulled into a switchback route SR, where its sense of traveling is reversed by way of switchback. Then, the sheet is transferred by drives such as rollers, to lead again to the register Rg. After a pause at the register Rg, the sheet is re-fed to the printing mechanism, to make a print on the backside in a similar manner to the front side, so that the sheet is printed on both sides. In due course, this sheet is discharged on the discharge tray 330a, to stack thereon.

The printing machine 10 employs an internal space of the discharge tray 330 for a switchback movement of a sheet to reverse the sense of travel. The internal space of discharge tray 330a is enveloped to keep the sheet from being taken out from outside during the switchback. This configuration prevents a switch-backing sheet from being pulled off by a mistake. The discharge tray 330a is an inherent accessory of the printing machine 10, so using the internal space of discharge tray 330a for switchback eliminates the need of an additional space secured for switchback in the printing machine 10. This permits the size of machine housing to be kept from increasing. Further, the switchback route is separated from a discharge route, so such the switchback process can be completed in parallel with discharge of any sheet else.

FIG. 3 is a functional block diagram of the printing machine 10 according to the present embodiment. As illustrated in the figure, the printing machine 10 includes a machine controller 110, a communication processor 120, an image scanner 130, an operation panel 150, a printer as a printing system 310, a feed system 320, a discharge system 330, and a transfer drive system 350.

The communication processor 120 implements protocol processes according to a connection format for communications with the PC 20. For instance, it executes TCP/IP (transmission control protocol/internet protocol) for a LAN connection. Further, the communication processor 120 receives a print data including a set of image data, from the PC 20 that is a source of image data.

The image scanner 130 is another source of image data that includes a light source, a lens system, a platen, a scan mechanism, a light receiving device, etc. It executes a process of scanning an original sheet on the platen, reading a frame of images thereon to convert into a series of electric signals, to output as a set of image data to the machine controller 110. The image scanner 130 may be installed inside or outside the printing machine 10.

The printing system 310 includes a printing mechanism using image forming media for forming images on a print sheet. This mechanism employs an ink jet system in which arrays of ink jets are propelled from the print heads 312 of a sheet-covering width to make a print by lines. The printing mechanism employed may be, for instance, a serial ink jet system, or an electro-photographic system using toners or the like.

The feed system 320 includes a plurality of sheet feeders configured to feed print sheets different in size, type, and/or orientation. Each sheet feeder has a feed tray or rack on which volumes of print sheets can be piled to set in place. In this embodiment, there are three pedestal trays being a first feed tray 320b, a second feed tray 320c, and a third feed tray 320c, and a single feed rack 320a exposed outside. There are available print sheets to be set in volumes, and selective from among sizes such as an A4, a B5, etc, and types such as a plain sheet, an inkjet print sheet, etc. Each tray is adapted to place therein volumes of sheets of a size, typically of a kind. The volumes of sheets set in place have an orientation selective between two being those for a long-sided feed and a short-sided feed. In the long-sided feed, the long edge of sheet is aligned with a feed direction, while in the short-sided feed the short edge of sheet is aligned with the feed direction. Each sheet feeder is provided with a sheet sensor to check for a paper-out.

The discharge system 330 is configured to discharge printed sheets, and provided with the discharge tray 330a for stacking sheets with face down. The discharge tray 330a has the sheet-full sensor 332a for detecting an excessive stacking, and the tray-empty sensor 334a to check for an empty state of the stacker (refer to FIG. 2). The provision of sheet-full sensor 332a may be replaced by, for instance, measuring a weight of sheet stack or counting discharged sheets to check for an excessive stacking.

The transfer drive system 350 includes drives, such as those composed of motors, configured to transfer print sheets. This system includes the transfer belt 352 located in a position facing the print heads 312, and configured to convey a sheet at a constant speed in the printing mechanism. Further, it includes the route selector 386 for selection between a sheet discharge route and a switchback section of the sheet transfer route (refer to FIG. 2).

The machine controller 110 is configured with a CPU, memories, etc, as necessary, to implement programmed processes, constituting an operation panel controller 111, a feed controller 113, a discharge controller 114, a transfer controller 115, a frame processor 116, a propelling controller 117, and an information manager 118.

The operation panel controller 111 implements a process of interpreting any user's operation input thereto through the operation panel 150 or via a frame displayed on the operation panel 150. The feed controller 113 responds to a given printing condition by setting up a sheet feeder to feed print sheets for a printing job, controlling the transfer drive system 350 to take in print sheets from the sheet feeder at preset timings. The feed controller 113 includes a feeder information manager 1131 to implement a process of receiving from user settings on a size, type, and orientation of print sheets placed in each sheet feeder, storing them in a memory.

The discharge controller 114 responds to a given printing condition by setting up a stacker for receiving discharged print sheets to stack thereon, whether the discharge system 330 has a single stacker or a plurality of stackers by option. The stacker being set up is informed to the transfer controller 115 to permit an ensured sheet discharge to the stacker.

The transfer controller 115 controls the transfer drive system 350 including the transfer belt 352 and other drives. More specifically, for each sheet under current control, the controller 115 sets a transfer route and a transfer speed, and outputs a control signal according to the setting to the drive system 350. The transfer route is determined in accordance with informed settings, such as a feeder setting, a stacker setting, and a duplex setting, and the transfer speed is determined depending on given printing conditions such as print quality and sheet type.

The frame processor 116 is adapted for necessary processes to provide a compatible print data to the printing system 310, including a conversion of data of image frame from an RGB system to a CMYK system. Converted image data may represent a set of dot maps per lines of C (cyan), M (magenta), Y (yellow), and K (black). The propelling controller 117 controls the print heads 312 to provide arrays of ink droplets propelled in accordance with given image data.

The information manager 118 has sets of pieces of information on sizes of regular sheets such as an A4, an A3, and a B5 registered thereto in advance, by storing them as size data of those sheets in a memory. The information manager 118 is adapted to accept registration of a user defined sheet in terms of information on a size of a sheet designated by user in a voluntary manner. Providing a possible handling by the feed system 320, any sheet can be registered as a user defined sheet, by operation of e.g. an authorized user to the operation panel 150. The user defined sheet registered is stored in a memory by the information manager 118. The user defined sheet may be defined by a set of pieces of information including a length, a width, and an identification code or name of the sheet.

Description is now made of a process of acquiring a size of a user defined sheet at the printer controller 210. As described above, at the printing machine 10, the information manager 118 is adapted to accept registration of a user defined sheet, and record a set of pieces of information on a size of the user defined sheet, by storing it as a size data of the sheet in a memory. On the other hand, at the printer controller 210, the user defined sheet size acquirer 2111 is adapted to acquire from the information manager 118 the size data of the user defined sheet recorded at the information manager 118. The size data thus acquired is recorded, as a size data of user defined sheet shared with the printing machine 10, to the printing condition setter 211 of the printer controller 210, to refer to when setting a printing condition, to use for a setting of user defined sheet in a manner similar to that of regular sheet.

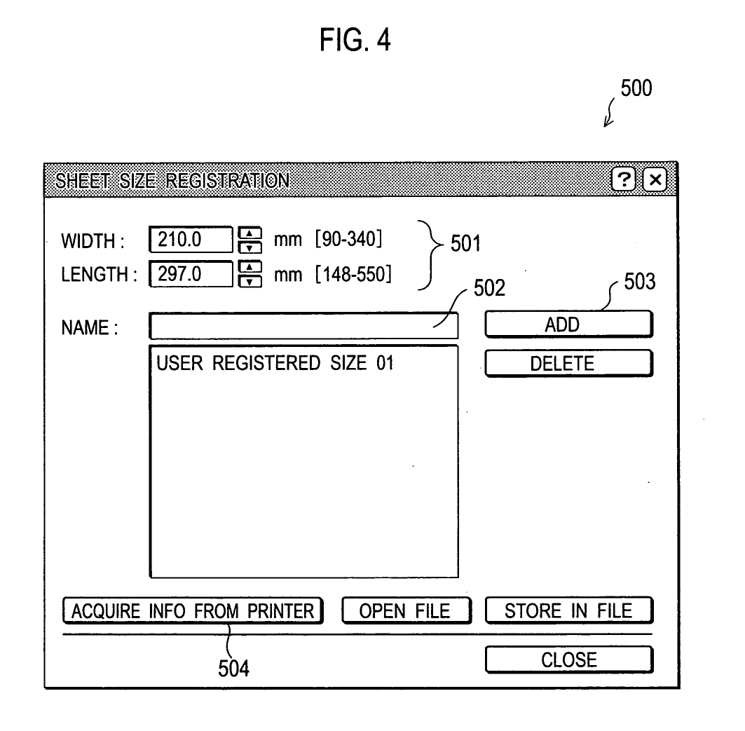

At the printer controller 210, the printing condition setter 211 is adapted to accept, directly from user, registration of an arbitrary sheet in terms of a size data subject to a possible handling by the feed system 320 of the printing machine 10. FIG. 4 illustrates a frame 500 for accepting registration of a size data of a sheet at the PC 20. The sheet size registration frame 500 may be displayed by acceptance of a prescribed button operation during a run of the printer controller 210.

Given the sheet size registration frame 500, user can input a length and a width of a sheet to corresponding fields in a size input region 501, and a voluntary name of the sheet to a name input field 502, and click an ADD button 503, to register the sheet as a user defined sheet in the printer controller 210. The registered user defined sheet can be designated as a print sheet for a printing job to make a print on a sheet according to the definition.

However, even in a situation having a user defined sheet registered to the printing machine 10, if it were compulsory to input a length, a width, and a name of the same sheet to the sheet size registration frame 500 for the registration to the printer controller 210, there would have been bothersome time and efforts, and besides, anxieties about a mistake in input operation that might cause an inconsistency with the user defined sheet registered at the end of the printing machine 10. Further, for a shared use of the printing machine 10 by a plurality of PCs, there would have been great burdens imposed on user, if it were compulsory to input a combination of length, width, and name for registration at each PC.

To this point, according to the embodiment as illustrated in FIG. 4, the sheet size registration frame 500 is provided with an “ACQUIRE INFO FROM PRINTER” button 504 operable for acquisition of a size data of a user defined sheet registered at the printing machine 10, to register the same at the end of the printer controller 210.

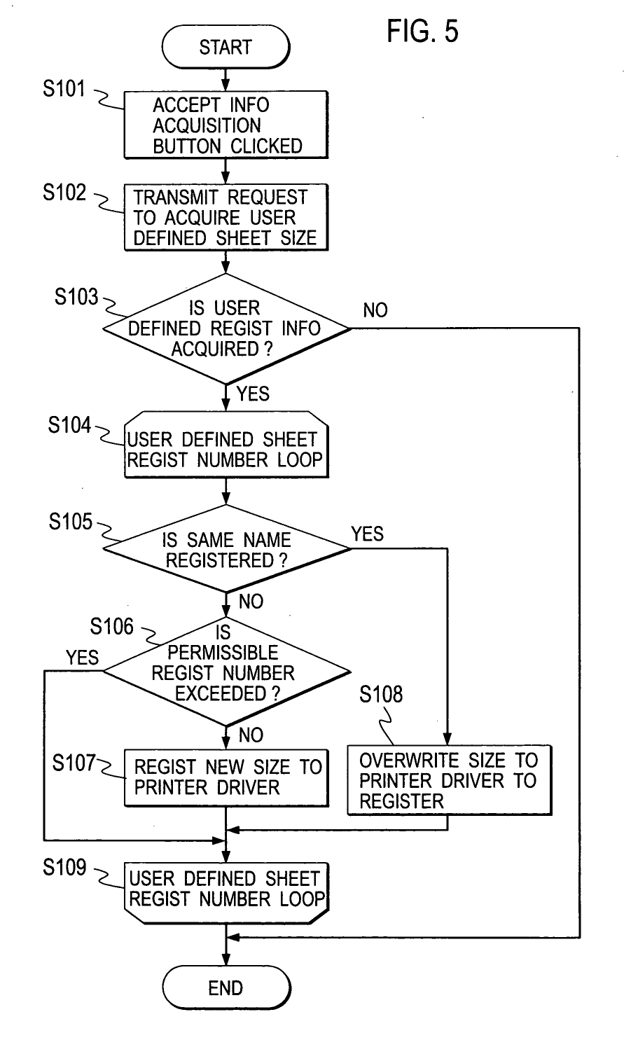

FIG. 5 is a flowchart of control actions of the printer controller 210 in a process after a click to the “ACQUIRE INFO FROM PRINTER” button 504. It is noted that the printer controller 210 can accept registration of a number of user defined sheets up to a preset upper limit.

At a step S101, the “ACQUIRE INFO FROM PRINTER” button 504 is clicked, and at a step S102, the user defined sheet size acquirer 2111 of the printer controller 210 sends to the information manager 118 of the printing machine 10 a request for acquisition of a size data of each user defined sheet registered therein. As a result, if any size data is acquired (Yes at the step S103), the flow goes to a series of subsequent steps S104 to S109 for a series of processes to be executed every acquired size data, and repeated a number of times corresponding to the number of acquired size data. On the other hand, in failure of size data acquisition (No at the step S103), the flow goes to an end.

In the course of processes at the steps S104 to S109, the flow first goes to a step S105 to check any and all size data of user defined sheets registered at the printer controller 210, for the same name as a name in an acquired size data being currently processed. As a result, if the same name is registered (Yes at the step S105), the flow goes to a step S108 to overwrite the acquired size data on a size data of a corresponding user defined sheet, for the registration.

Unless the same name is registered (No at the step S105), the flow goes to a step S106 to check for a number of registered user defined sheets exceeding the upper limit. Unless the upper limit is exceeded (No at the step S106), the flow goes to a step S107 to record the acquired size data in a blank record field to thereby make registration of a corresponding new user defined sheet to the printer controller 210. If the upper limit of number of registered user defined sheets is exceeded (Yes at the step S106), there will be no registration of user defined sheet. The above-noted series of processes will be repeated to complete registration at the printer controller 210 with respect to any and all user defined sheets registered at the printing machine 10.

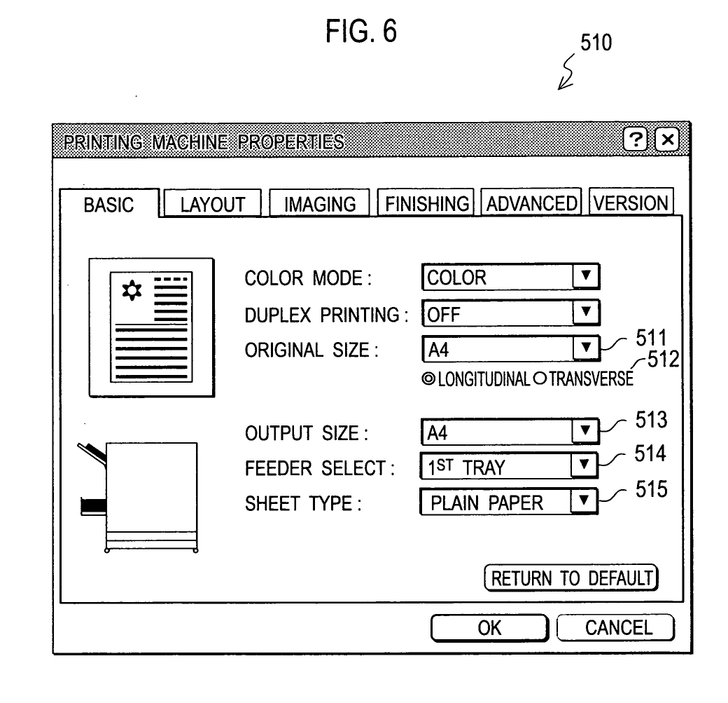

Thus registered user defined sheets as well as regular sheets having been registered at the printer controller 210 are each selective to use as a print sheet, when setting a printing condition. FIG. 6 illustrates a printing machine property frame 510 as one of printing condition setup frames for accepting printing conditions to be set in the print system of FIG. 1.

The printing machine property frame 510 includes: an original size select field 511 to indicate an original size setup menu for setting a size of original sheet; a longitudinal (portrait)-transverse (landscape) attitude select field 512 indicating a sheet orientation setup menu for setting an orientation of original or print sheet; a sheet size select field 513 to indicate an sheet size setup menu for setting a size of print sheets to be output; a feeder select field 514 to indicate a feeder setup menu for setting a feeder to be used and a sheet type select field 515 to indicate an sheet type setup menu for setting a type of print sheet.

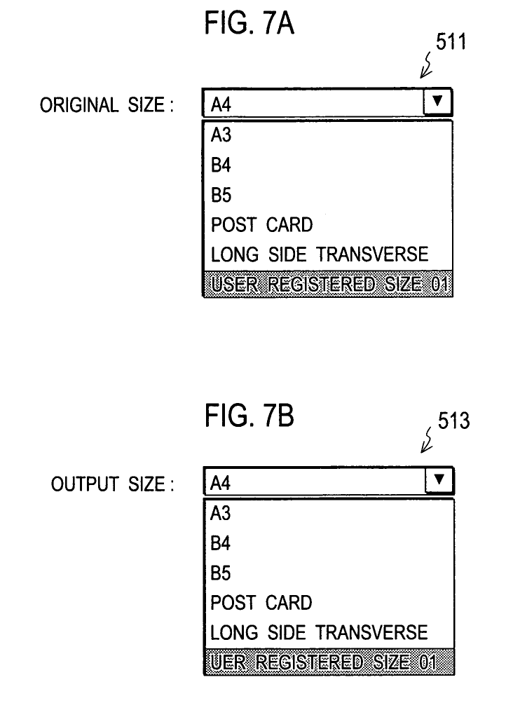

The printer controller 210 thus has one or more user defined sheets registered thereto, of which names will be listed for selection in a pull-down menu of the original size select field 511 illustrated in FIG. 7A, and in a pull-down menu of the sheet size select field 513 illustrated in FIG. 7B.

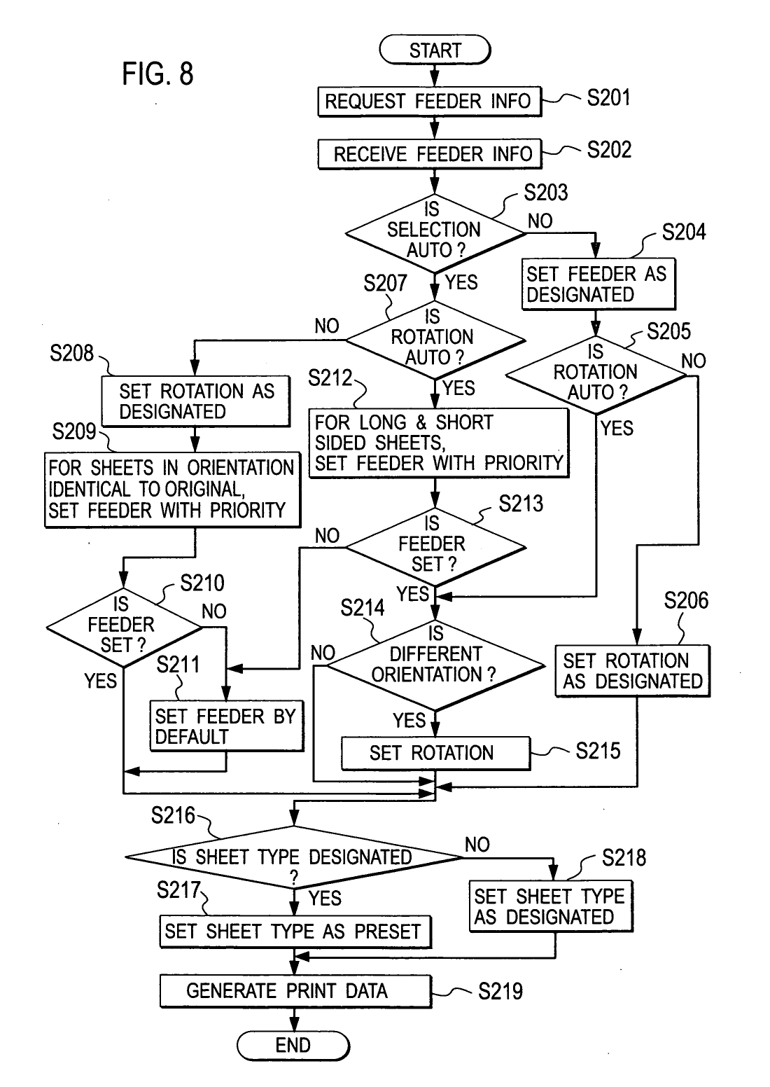

Description is now made of a feeder setup process and a print data generation process at the printer controller 210, with reference to a flowchart shown in FIG. 8. This flowchart represents processes to be implemented at the printer controller 210 with an instruction received from user for execution of a printing job. There is a set of printing conditions set up in advance of the user's instruction for print execution. The property frame 510 illustrated in FIG. 6 is employed to set up the set of printing conditions.

For the printing job, the setup of printing conditions includes using: the longitudinal-transverse attitude select field 512 to designate an orientation of original sheet; the sheet size select field 513 to designate a size of print sheet; the feeder select field 514 to select a sheet feeder; and the sheet type select field 515 to select a sheet type. The property frame 510 has a hidden setup field that permits selection of an angle of rotation of image frame.

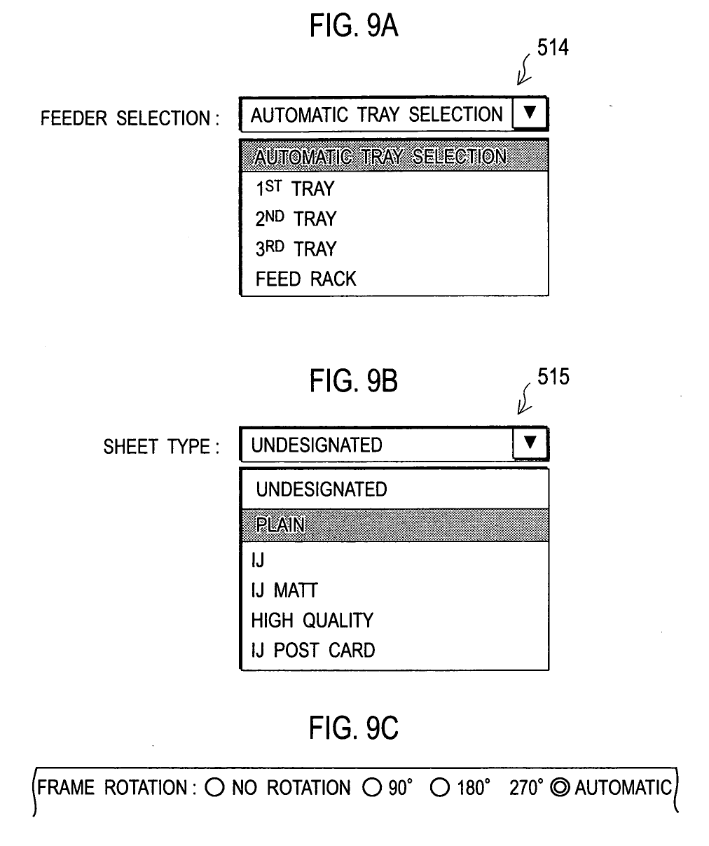

As illustrated in FIG. 9A, the feeder selection may include designating a specific sheet feeder, such as “1^{ST} TRAY” or “FEED RACK”, or alternatively selecting “AUTOMATIC TRAY SELECTION”. After designation of a specific sheet feeder, this sheet feeder is set up as a sheet feeder for the printing job. In “AUTOMATIC TRAY SELECTION”, a later-described procedure is applied to set up a sheet feeder for the printing job.

As illustrated in FIG. 9B, the sheet type selection may include designating a specific sheet type, such as “PLAIN” or “IJ MATT”, or alternatively selecting “UNDESIGNATED”. After designation of a specific sheet type, this sheet type is set up as a sheet type for the printing job. In selection of “UNDESIGNATED”, a later-described procedure is applied to set up a sheet type for the printing job. It is noted that the print data generator 212 shown in FIG. 1 is adapted for a color matching using an ICC (Internet Color Consortium-compliant) profile consistent with properties of a sheet type as set up to generate a print data. The print data is generated with a maximum propelling rate of ink droplets per pixel controlled in accordance with properties of print sheet.

As illustrated in FIG. 9C, the image frame rotation angle selection may include designating a specific image frame rotation, such as “NO ROTATION” or “90°”, or selecting “AUTOMATIC” for automatic setup of image frame rotation. After designation of a specific image frame rotation, the image frame to be printed is rotated in accordance with that designation. In selection of “AUTOMATIC”, a later-described procedure is applied to set up an angle of image frame rotation.

At a step S201, given a user's instruction for print execution, the feeder information acquirer 2112 of the printer controller 210 sends a request for information on every sheet feeder to the feeder information manager 1131 of the printing machine 10. At a step S202, the feeder information acquirer 2112 receives feeder information from the feeder information manager 1131. In other words, it acquires information on a size, an orientation, and a type of print sheets placed in each sheet feeder. There will be described setting a sheet feeder and setting an image frame rotation, for two patterns of printing conditions being one including “AUTOMATIC” feeder selection and the other excluding the same, respectively.

<Pattern 1: Non-“AUTOMATIC” Feeder Selection>

Unless the printing condition setup includes “AUTOMATIC” feeder selection (No at a step S203), that is, if user has designated a specific sheet feeder, the control flow goes to a step S204 to set up the designated sheet feeder as a sheet feeder for an associated printing job.

Then, unless the selection of image frame rotation is “AUTOMATIC” (No at a step S205), that is, if user has designated a specific angle of image frame rotation, the control flow goes to a step S204 to set up the designated angle of image frame rotation.

In the case the selection of image frame rotation is “AUTOMATIC” (Yes at the step S205), if the orientation of sheets placed in the sheet feeder designated by user is different from an orientation of sheet set up as a printing condition (Yes at a step S214), the control flow goes to a step S215 to set up an angle of image frame rotation so that the orientation of sheet set up as a printing condition coincides with an orientation of sheets placed in a sheet feeder.

The foregoing procedure applies to setting a feeder and an angle of image frame rotation in the case the selection of image frame rotation is not “AUTOMATIC”.

<Pattern 2: “AUTOMATIC” Feeder Selection>

Description is made of the pattern of printing conditions including “AUTOMATIC” feeder selection (Yes at the step S203), i.e., of the case in which user has not designated any specific sheet feeder.

Unless the selection of image frame rotation is “AUTOMATIC” (No at a step S207), that is, if user has designated a specific angle of image frame rotation, the control flow goes to a step S208 to set up the designated angle of image frame rotation.

Then, at a step S209, there is a check to sheet feeders in each of which placed sheets are oriented in an identical direction or sense to an orientation of sheet set up as a printing condition, for a sheet feeder in which placed sheets have an identical size to a size of sheet set up as a printing condition, and this feeder is set up as a sheet feeder for an associated printing job. The check to sheet feeders may be made in accordance with a preset order of priority.

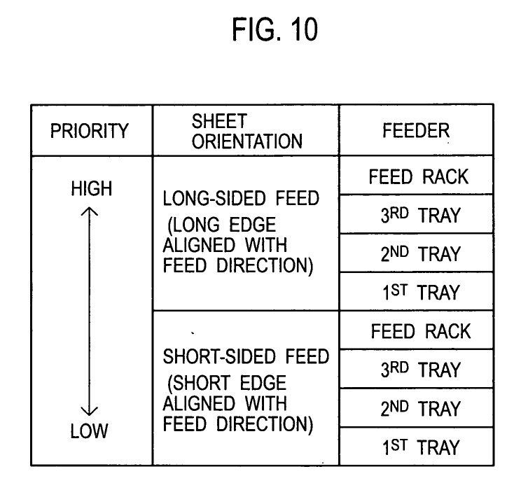

FIG. 10 shows an example of order of priority of sheet feeders. In this example, those feeders in each of which placed sheets are oriented for a long-sided feed have higher priorities than those feeders in each of which placed sheets are oriented for a short-sided feed. This is because the printing machine 10 has employed the print heads 312 of a line printing type that simultaneously prints a line, permitting the long-sided feed to render the print time shorter. Whether long-sided feed or short-sided feed, the priority descends in the order of feed rack 320a, third tray 320d, second tray 320c, and first tray 320b. There may be a setting to exclude a specific feeder from among retrieval targets.

In the case the selection of image frame rotation is “AUTOMATIC” (Yes at the step S207), i.e., if user has not designated any specific angle of image frame rotation, then the control flow goes to a step S212 to check all sheet feeders, irrespective of orientation of placed sheets, for a sheet feeder in which placed sheets have an identical size to a size of sheet set up as a printing condition, and set up this feeder as a sheet feeder for an associated printing job. The check to sheet feeders may be made in accordance with a preset order of priority.

In the case the selection of image frame rotation is “AUTOMATIC”, if the retrieved sheet feeder is successfully set up (Yes at a step S213) and if the orientation of sheets placed in the sheet feeder designated by user is different from an orientation of sheet set up as a printing condition (Yes at the step S214), the control flow goes to the step S215 to set up an angle of image frame rotation so that the orientation of sheet set up as a printing condition coincides with an orientation of sheets placed in the sheet feeder being set up.

In either case, if the retrieval for a sheet feeder meeting the condition is failed, with a resultant failure in feeder setup (No at a step S210 or No at the step S213), then the flow goes to a step S211 to set up a separately set default sheet feeder as a sheet feeder for an associated printing job.

The foregoing procedure applies to setting a sheet feeder and an angle of image frame rotation, in the case the selection of sheet feeder is “AUTOMATIC”.

<Setting Sheet Type>

Description is now made of setting a type of sheet after setups of sheet feeder and angle of image frame rotation. Unless the selection of sheet type in a given set of printing conditions is “UNDESIGNATED” (No at a step S216), i.e., if user has designated a specific type of sheet, then the control flow goes to a step S218 to set up the designated sheet type as a sheet type for an associated printing job.

In the case the selection of sheet type is “UNDESIGNATED” (Yes at the step S216), i.e., if user has not designated any specific type of sheet, then the control flow goes to a step S217 to set up a type of sheet placed in a sheet feeder having been set in the foregoing procedure, as a sheet type for an associated printing job.

Then, at a step S219, the print data generator 212 serves to generate a print data in accordance with setups of image frame rotation and sheet type in the foregoing procedure, and designate a sheet feeder being set up, as a sheet feeder for an associated printing job. More specifically, it is adapted to rotate an image frame to be printed in accordance with a setup of angle of image frame rotation, make a color matching using an ICC profile compatible with a setup of sheet type, and control the maximum propelling rate of ink droplets per pixel.

The foregoing procedures may be summarized as follows. If user has designated a specific sheet feeder, the designated feeder is to be set up as a sheet feeder for an associated printing job, irrespective of acquired information on sheet feeders. In the case the selection of sheet feeder is “AUTOMATIC”, if user has designated a specific angle of image frame rotation, then a setup is made of a sheet feeder in which placed print sheets are consistent with both sheet size and sheet orientation set up as printing conditions, according to an order of priority, or if user has not designated any specific angle of image frame rotation, then a setup is made of a sheet feeder in which placed print sheets are consistent with a sheet size set up as a printing condition, according to the order of priority.

Further, in the case user has designated a specific angle of image frame rotation, the designated image frame rotation is effected in a generated print data irrespective of acquired information on sheet feeders. In the case user has not designated any specific angle of image frame rotation, there is an image frame rotation effected in a generated print data, as necessary, in correspondence to an orientation of print sheets placed in a sheet feeder for an associated printing job.

Further, in the case user has designated a specific angle of image frame rotation, there follows, irrespective of acquired information on sheet feeders, a color matching using an ICC profile according to a designated sheet type, combined with controlling a maximum propelling rate of ink droplets per pixel, to generate a print data. In the case user has not designated any specific angle of image frame rotation, there follows a color matching using an ICC profile according to a type of sheets placed in a sheet feeder to be used for an associated printing, combined with controlling a maximum propelling rate of ink droplets per pixel, to generate a print data.

According to the present embodiment, the foregoing series of processes permits acquisition of a set of pieces of information on a size, an orientation, and a type of sheets placed in a respective sheet feeder of a printing machine, allowing for an adequate selection of sheet feeder in accordance with a given set of printing conditions, as well as for generation of a print data to form an adequate image frame commensurate with print sheets placed in a thus selected sheet feeder. Accordingly, even if user has not designated any specific sheet feeder, the embodiment according to the present invention can provide a printer controller, a printing server, and a print system allowing for an ensured generation of a print data commensurate with a type of print sheet.

While the preferred embodiments of the present invention have been described using specified terms, such description is for illustrative purposes, and it is to be understood that changes and variations may be made without departing from the spirit or scope of the following claims.

This application is based upon the Japanese Patent Application No. 2008-271158, filed on Oct. 21, 2008, the entire content of which is incorporated herein by reference.

What is claimed is:

1. A computer program product providing a printer controller configured for an information processor to execute a process of outputting a print data to a printing machine provided with a plurality of sheet feeders and adapted to set up feeder information including information on a size, an orientation, and a type of print sheets placed in a respective sheet feeder, the computer program product comprising:
a feeder information acquirer configured to acquire the feeder information from the printing machine;
a printing condition acceptor configured to accept a set of printing conditions including a sheet size and a sheet type set up as printing conditions; and
a print data generator configured to generate the print data to have the printing machine form a frame of images,
the printer controller being configured to have the information processor work as a feeder setter to set up a sheet feeder for print,
the feeder setter being adapted, to set up a sheet feeder in which placed print sheets have an identical size to a sheet size set up as a printing condition, as the sheet feeder for print, in accordance with the feeder information as acquired,
the print data generator being adapted to generate the print data to have an image frame formed by the print data oriented in accordance with an orientation of print sheets placed in the sheet feeder set up as the sheet feeder for print, and form the image frame in accordance with a type of print sheets placed in the sheet feeder as set up.

2. The computer program product according to claim 1, wherein
the print data generator is adapted to make a color matching in accordance with a type of print sheet, to generate the print data to form the image frame in accordance with a type of print sheets placed in the sheet feeder as set up.

3. The computer program product according to claim 1, wherein
the printing machine comprises an inkjet printer configured to propel ink droplets for print, and
the print data generator is configured to control a maximum ink droplet propelling rate per pixel in accordance with a sheet type, to generate the print data to form the image frame in accordance with the type of print sheets placed in the sheet feeder as set up.

4. The computer program product according to claim 1, wherein
the printing condition acceptor is adapted to accept a selection of sheet feeder set up as a printing condition, and
the feeder setter is adapted without any accepted selection of any specific sheet feeder, to set up the sheet feeder in which placed print sheets have the identical size to the sheet size set up as a printing condition, as the sheet feeder for print, in accordance with the feeder information as acquired.

5. The computer program product according to claim 4, wherein
the feeder setter is adapted to comply with a preset order of priorities of sheet feeders, to set up the sheet feeder in which placed print sheets have the identical size to the sheet size set up as a printing condition, as the sheet feeder for print.

6. The computer program product according to claim 4, wherein
the printing condition acceptor is adapted to accept a selection of image frame rotation set up as a printing condition, and
the feeder setter is adapted:
with an accepted selection of a specific image frame rotation, to set up from among sheet feeders in each of which placed sheets have an orientation consistent with a sheet orientation set up as a printing condition, the sheet feeder in which placed print sheets have the identical size to the sheet size set up as a printing condition, as the sheet feeder for print; and
without any accepted selection of any specific image frame rotation, to set up from among the plurality of sheet feeders, the sheet feeder in which placed print sheets have the identical size to the sheet size set up as a printing condition, as the sheet feeder for print.

7. The computer program product according to claim 1, wherein
the printing condition acceptor is adapted to accept a selection of sheet type set up as a printing condition, and
the print data generator is adapted without any accepted selection of any specific sheet type, to generate the print data in accordance with the type of print sheets placed in the sheet feeder as set up.

8. The computer program product according to claim 1, wherein
the printing machine is adapted to register an arbitrary size data of print sheet as a size data of user defined sheet,
the printer controller is adapted to have the information processor work as:
a size acquirer configured to acquire from the printing machine the size data of user defined sheet registered at the printing machine; and
a size selection acceptor configured to display a set of size data of print sheets including the size data of user defined sheet as acquired, to accept a selection of size data therefrom, and
the print data generator is adapted to generate the print data in accordance with the selection of size data at the size selection acceptor.

9. A printing server configured to output a print data to a printing machine provided with a plurality of sheet feeders and adapted to set up feeder information including information on a size, an orientation, and a type of print sheets placed in a respective sheet feeder, the printing server comprising:
a feeder information acquirer configured to acquire the feeder information from the printing machine;
a printing condition acceptor configured to accept a set of printing conditions including a sheet size and a sheet type set up as printing conditions;
a print data generator configured to generate the print data to have the printing machine form a frame of images, and
a feeder setter to set up a sheet feeder for print,
the feeder setter being adapted, to set up a sheet feeder in which placed print sheets have an identical size to a sheet size set up as a printing condition, as the sheet feeder for print, in accordance with the feeder information as acquired,
the print data generator being adapted to generate the print data to have an image frame formed by the print data oriented in accordance with an orientation of print sheets placed in the sheet feeder set up as the sheet feeder for print, and form the image frame in accordance with a type of print sheets placed in the sheet feeder as set up.

10. A print system including a printing machine provided with a plurality of sheet feeders and adapted to set up feeder information including information on a size, an orientation, and a type of print sheets placed in a respective sheet feeder, and a printing server configured to output a print data to the printing machine, the printing server comprising:
a feeder information acquirer configured to acquire the feeder information from the printing machine;
a printing condition acceptor configured to accept a set of printing conditions including a sheet size and a sheet type set up as printing conditions;
a print data generator configured to generate the print data to have the printing machine form a frame of images, and
a feeder setter to set up a sheet feeder for print,
the feeder setter being adapted, to set up a sheet feeder in which placed print sheets have an identical size to a sheet size set up as a printing condition, as the sheet feeder for print, in accordance with the feeder information as acquired,
the print data generator being adapted to generate the print data to have an image frame formed by the print data oriented in accordance with an orientation of print sheets placed in the sheet feeder set up as the sheet feeder for print, and form the image frame in accordance with a type of print sheets placed in the sheet feeder as set up.
